(19) United States
(12) Patent Application Publication
(10) Pub. No.: US 2026/0195397 A1
(43) Pub. Date: Jul. 9, 2026

(54) TECHNIQUES FOR SHARING CONTENT LINKS IN MULTIMEDIA SYSTEM

(71) Applicant: Roku, Inc., San Jose, CA (US)

(72) Inventors: Frank Llewellyn Maker, Livermore, CA (US); Gregory Mack Garner, Key Colony Beach, FL (US); David Lee Stern, Los Gatos, CA (US)

(73) Assignee: Roku, Inc., San Jose, CA (US)

(21) Appl. No.: 19/013,772

(22) Filed: Jan. 8, 2025

(51) Int. Cl. G06F 16/955

(52) U.S. Cl. CPC G06F 16/9558

(57) ABSTRACT

A method is described and includes receiving by a content link sharing system a request for a content link associated with content being viewed by a user; generating by the content link sharing system the requested content link; and providing by the content link sharing system the generated content link, wherein the content link is configured to be copied by the user and shared with at least one recipient.

### TECHNICAL FIELD

This disclosure relates to multimedia systems, and more specifically, to techniques for sharing content links in such systems.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of an example multimedia system, according to some embodiments of the disclosure.

FIG. 2 illustrates a block diagram of an example media device, according to some embodiments of the disclosure.

FIGS. 3A, 3B, 4A, and 4B are flowcharts illustrating example operations that may be performed by a content link sharing system in a multimedia system, according to some embodiments of the disclosure.

FIG. 5 is a block diagram of an example computing device, according to some embodiments of the disclosure.

### DETAILED DESCRIPTION

### Overview

Multimedia systems, such as digital streaming platforms, may provide one or more mechanisms by which a user can interact with the system through spoken commands. For example, voice assistants enable users to use voice commands to perform a task, such as to change a setting of a device, retrieve information, request content item(s), make a purchase, offer information, etc. Voice assistants may include components such as automatic speech recognition, natural language understanding, and dialogue state tracking. Automatic speech recognition may use acoustic and language models to convert audio signals of user utterances into natural language text input to the system.

In accordance with features of embodiments described herein, a link to content viewed by a user on a proprietary streaming service platform may be generated in response to a user query entered via voice or text. The link may comprise a Uniform Resource Locator (URL), a Quick Response (QR) code, or a proprietary token, for example and may be shared by the user with one or more recipients via an internal (e.g., within the proprietary streaming service platform) or external communications mechanism, such as text, email, iMessage, or social media, for example. The link may include metadata, such as a category of the content, a thumbnail of the content, and a short description of the content, for example, which may be presented to the recipient along with the link. In particular embodiments, a recipient's clicking on the received link may trigger one or more of a variety of actions, including launching the content on a device of the recipient, displaying metadata associated with the content, adding content to a watch list of the recipient, updating preferences of the recipient within the proprietary streaming service platform, and/or adding the recipient to an internal social network of the user, for example.

### Example Multimedia System

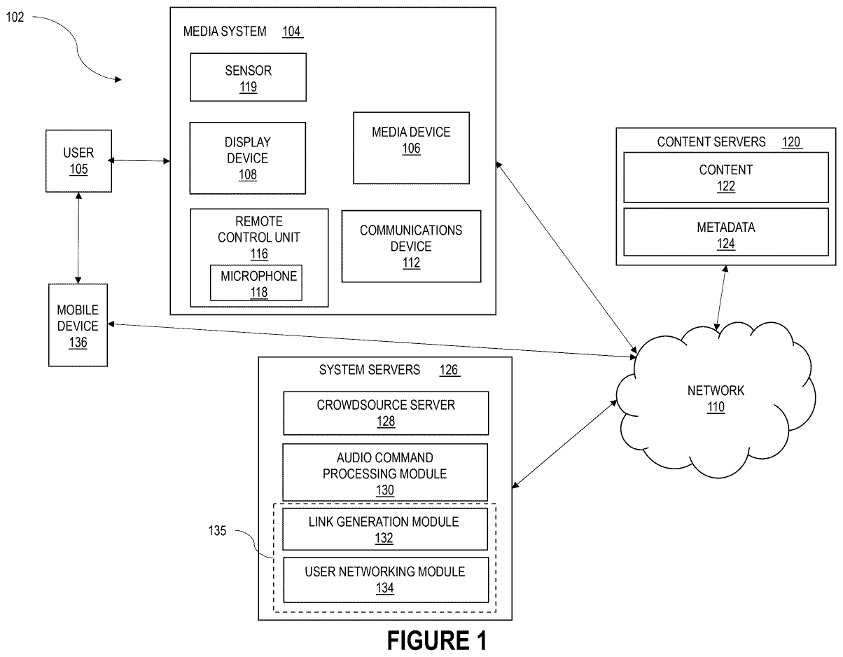

FIG. 1 illustrates a block diagram of an example multimedia system 102 according to some embodiments described herein. In a non-limiting example, multimedia system 102 may be directed to digital streaming media; however, embodiments described herein may be applicable to any type of media instead of or in addition to streaming media, as well as any type of mechanism, means, protocol, method, and/or process for distributing media.

Multimedia system 102 may include one or more media systems, such as media system 104. Media system 104 may represent a family room, a kitchen, a backyard, a home theater, a school classroom, a library, a car, a boat, a bus, a plane, a stadium, a movie theater, an auditorium, a bar, a restaurant, an extended reality (XR) space, and/or any other location or space where it may be desirable to receive, interact with, and/or play streaming content. Users, such as a user 105, may interact with media system 104 as described herein to select, view, interact with, and/or otherwise consume content.

Each media system 104 may include one or more media devices, such as media device 106, each of which may be coupled to one or more display devices, such as display device 108 (which may be implemented as an A/V device). It will be noted that terms such as “coupled,” “connected,” “attached,” “linked,” “combined,” as well as similar terms, may refer to physical, electrical, magnetic, local, and/or other types of connections, unless otherwise specified herein.

Media device 106 may include a streaming media device, DVD or BLU-RAY device, audio/video playback device, cable box, an XR device (which may include one or more of a VR device, an AR device, and an MR device), and/or digital video recording device, for example. Media device 106 may enable content from multiple content provider platforms and/or content channels to be displayed. In particular embodiments, media device 106 may be associated with a proprietary streaming service platform. Display device 108 may include a monitor, a television, a computer, a smart phone, a tablet, a wearable (e.g., a watch, glasses, goggles and/or an XR headset), an appliance, an Internet of things (IoT) device, and/or a projector, for example. In some embodiments, media device 106 may be a part of, integrated with, operatively coupled to, and/or connected to one or more respective display devices, such as display device 108.

Media device 106 may be configured to communicate with network 110 via a communications device 112. Communications device 112 may include, for example, a cable modem or satellite TV transceiver. Media device 106 may communicate with the communications device 112 over a link that may include wireless (e.g., Wi-Fi) and/or wired connections.

In various embodiments, network 110 may include, without limitation, wired and/or wireless intranet, extranet Internet, cellular, Bluetooth, infrared, and/or any other short range, long range, local, regional, and/or global communications mechanism, means, approach, protocol, and/or network, as well as any combinations thereof.

Media system 104 may include a remote control device 116. Remote control device may include and/or be incorporated into any component, part, apparatus, and/or method for controlling media device 106 and/or display device 108, such as a remote control, a tablet, a laptop computer, a smartphone, a wearable, on-screen controls, integrated control buttons, audio controls, XR equipment, and/or any combination thereof, for example, In one embodiment, remote control device 116 wirelessly communicates with media device 106 and/or display device 108 using any wireless communications protocol. Remote control device 116 may include a microphone 118. Media system 104 may also include one or more sensors, such as sensor 119, which may be deployed for tracking movement of user 105, such as in connection with XR applications. In particular embodiments, sensor 119 may include one or more of a gyroscope, a motion sensor, a camera, an IMU, and a biometric sensor, for example. Sensor 119 may also include one or more sensing devices for sensing biometric characteristics associated with sympathetic arousal, including one or more of heart rate variability (HRV), electrodermal activity (EDA), pupil opening, and/or eye movement. In some embodiments, sensors, such as sensor 119, may be incorporated into a device to be worn by users, such as a headset or vest. In particular embodiments, sensor 119 may comprise any sort of XR device.

Multimedia system 102 may include a plurality of content servers 120, which may also be referred to as content providers or sources. Although only one content server 120 is shown in FIG. 1, multimedia system 102 may include any number of content servers 120, each of which may be configured to communicate with network 110. Content servers 120 may be managed by one or more content providers, including the proprietary streaming service platform with which media device 106 is associated, as well as third party (3P) streaming service platforms. It will be noted that proprietary streaming service platform may have agreements with 3P streaming service platforms regarding provision of content and use of data owned by 3P streaming service platforms restricting the use thereof by the former. Each content server 120 may store content 122 and metadata 124. Content 122 may include media content, such as audio content, video content, image content, XR (e.g., VR, AR, and/or MR) content, gaming application content, advertising content, software content, and/or any other content or data objects in electronic form. Features or attributes of content 122 may include but are not limited to popularity, topicality, trend, statistical change, most-talked or most-discussed about, critics ratings, viewers ratings, length/duration, demographic-specific popularity, segment-specific popularity, region-specific popularity, cost associated with a content item, revenue associated with a content item, subscription associated with a content item, and amount of advertising, for example.

In particular embodiments, metadata 124 may include data about content 122. For example, metadata 124 may include but is not limited to such information pertaining or relating to content 122 as plot line, synopsis, director, list of actors, list of artists, list of athletes/teams, list of writers, list of characters, length of content item, language of content item, country of origin of content item, genre, category, tags, presence of advertising content, viewers'ratings, critic's ratings, parental ratings, production company, release date, release year, platform on which the content item is released, whether it is part of a franchise or series, type of content item, sports scores, viewership, popularity score, minority group diversity rating, audio channel information, availability of subtitles, beats per minute, list of filming locations, list of awards, list of award nominations, seasonality information, scene and video understanding, and emotional understanding of the scene based on visual and dialogue cues, for example. Metadata 124 may additionally or alternatively include links to any such information pertaining to or relating to content 122. Metadata 124 may additionally or alternatively include one or more indices of content 122.

Multimedia system 102 may include one or more system servers 126, which operate to support media device 106 from the cloud. In particular embodiments, structural and functional aspects of system servers 126 may wholly or partially exist in the same or different ones of system servers 126. One or more system servers 126 may be associated with the proprietary streaming services platform with which media device 106 is associated.

Media devices, such as media device 106, may exist in numerous media systems, such as media system 104. Accordingly, media device 106 may lend itself to crowd sourcing embodiments and system servers 126 may include one or more crowdsource servers 128. System servers 126 may also include an audio command processing module 130. As noted above, remote control device 116 may include a microphone 118, which may receive audio data from user 105 as well as from other sources, such as display device 108. In some embodiments, media device 106 may be audio responsive and the audio data may represent verbal commands from user 105 to control media device 106 as well as other components in media system 104, such as display device 108.

In some embodiments audio data received by microphone 118 is transferred to media device 106, which is then forwarded to audio command processing module 130. The audio command processing module 130 may operate to process and analyze the received audio data to recognize a verbal command from user 105. Audio command processing module 130 may then forward the verbal command to media device 106 for processing. In some embodiments, audio data may be additionally or alternatively processed and analyzed by an audio command processing module in media device 106 and system servers 126 may cooperate to select one of the verbal commands to process.

For purposes that will be described in greater detail below, system servers 126 may further include a link generation module 132 and a user networking module 134. Link generation module 132 enables generation of a link in response to a user query that user 105 may share via external communications mechanisms, such as text, iMessaging, email, and social media, for example, to enable the recipient(s) of the link to access content being viewed by the user. It will be recognized that the functionality provided by link generation module 132 may additionally and/or alternatively be provided by content servers 120. User networking module 134 networks of connections between user 105 and other users, all of whom may subscribe to one or more of the same streaming and/or content platforms, to be built and maintained for various purposes. Modules 132 and 134 together may comprise a system 135 for sharing content links in multimedia system 102.

In particular embodiments, a mobile device 136 may be included in multimedia system 102 and may have installed thereon a mobile app associated with the proprietary streaming services platform for enabling user 105 to interact with and/or control aspects of multimedia system 102, and particularly media device 106, via a user interface (UI) displayed on a display of mobile device 136. In some embodiments, mobile device 136 may incorporate, duplicate, and/or replace some or all features and/or functions of remote control unit 116. In some embodiments, mobile app of mobile device 136 may enable User 105 to perform a variety of functions, which may include but are not limited to:
searching for content using voice or typed search commands;
viewing streamed content on the display of the mobile device;
casting media files to display device;
adding and/or launching streaming services and/or channels on the media device; and
entering text commands to multimedia system (e.g., media device) using the keyboard of the mobile device.

### Example Media Device for Multimedia System

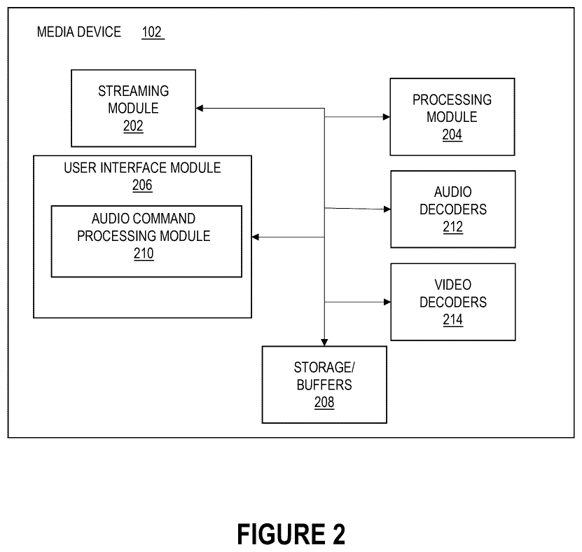

FIG. 2 illustrates a block diagram of an example media device 106 according to some embodiments. Media device 106 may include a streaming module 202, processing module 204, a user interface module 206, and storage/buffers 208. As noted above, user interface module 206 may include an audio command processing module 210.

As shown in FIG. 2, media device 106 may also include one or more audio decoders 212 and one or more video decoders 214. Each audio decoder 212 may be configured to decode one or more audio formats, including but not limited to AAC, HE-AAC, AD3 (Dolby Digital), EAC3 (Dolby Digital Plus), WMA, WAV, PCM, MP3, OGG GSM, FLAC, AU, AIFF, and/or VOX, for example. Similarly, each video decoder 214 may be configured to decode video of one or more video formats, including but not limited to MP4 (e.g., mp4, m4a, m4v, f4v, f4a, m4b, m4r, f4b, mov), 3GP (e.g., 3gp, 3gp2, 3g2, 3gpp, 3gpp2), OGG (e.g., ogg, oga, ogv, ogx), WMV (e.g., wmv, wma, asf), WEBM, FLV, AVI, QuickTime, HDV, MXF, MPEG-TS, MPEG-2 PS, MPEG-2 TS, WAV, Broadcast WAV, LXF, GXF, and/or VOB, for example. Each video decoder 214 may include one or more video codecs, such as H.263, H.264, H.265, HEV, MPEG1, MPEG2, MPEG-TS, MPEG-4, Theora, 3GP, DV, DVCPRO, DVCProHD, IMX, XDCAM HD, XDCAM HD422, AND XDCAM EX, for example.

Referring now to both FIGS. 1 and 2, in some embodiments, user 105 may interact with media device 106 via, for example, remote control device 116. For example, user 105 may use remote control device 116 to interact with user interface module 206 of the media device 106 to select content, such as a movie, TV show, music, book, application, game, etc. The streaming module 202 of media device 106 may request the selected content from content servers 120 over network 110. Content servers 120 may transmit the requested content to the streaming module 202. Media device 106 may transmit the received content to the display device 108 for playback to user 105.

In streaming embodiments, streaming module 202 may transmit content to display device 108 in real time or near real time as it receives such content from content servers 120. In non-streaming embodiments, media device 106 may store content received from content servers 120 in storage/buffers 208 for later playback on display device 108, for example.

### Example Techniques for Sharing Content Links in Multimedia Systems

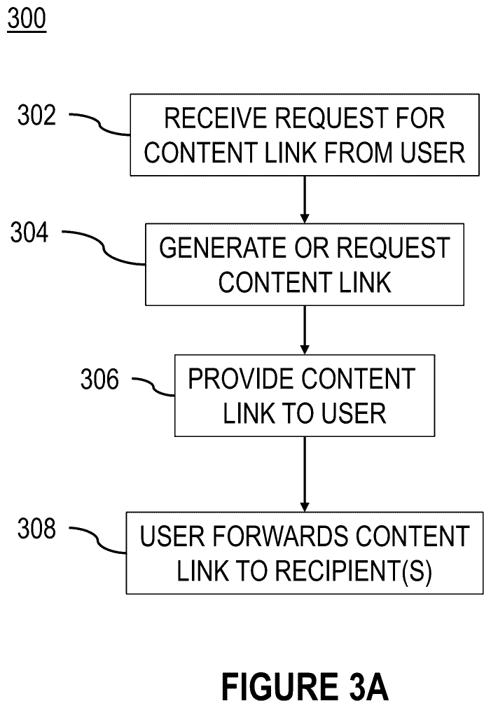

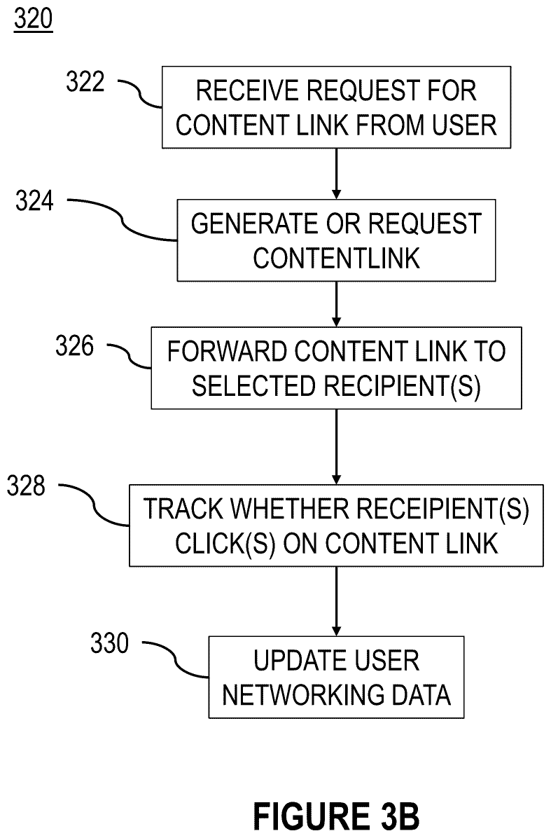

FIG. 3A is a flow diagram 300 of example operations performed by a content link sharing system, such as system 135 (FIG. 1) according to some embodiments of the disclosure. In certain embodiments, one or more of the operations illustrated in FIG. 3A may be performed by one or more of the elements illustrated in FIGS. 1-2, for example.

In an operation 302, a request for a content link is received from a user. In particular embodiments, the request is made while the user is viewing the content for which the content link is requested on the system 102 or on the user's mobile device 136 and may be made in the manner that any queries or requests may be made of the system, such as text, voice, or selection from a menu displayed on the user's mobile device or a display of the system.

In an operation 304, the content link is either generated, if the content is provided by a content server associated with the proprietary streaming platform on which the content is being viewed, or requested from a 3P streaming platform with which the content server from which the content is being streamed is provided (i.e., if system 102 does not have access to information about the content, including the identity thereof and/or metadata associated therewith). The content link may be in one of a variety of formats, including a URL, a QR code, or a token. The content link may include information about the user and may be in a format requested by the user. The content link may include an identity of the content, metadata associated with the content, and/or a thumbnail associated with the content. The content link may have a timestamp and may be set to expire after a predetermined amount of time.

In an operation 306, the content link generated or requested and received in operation 304 is provided to the user. The content link may be provided to the user in one of a variety of formats, including displayed on a display of the multimedia system 102 or the mobile device 136 or provided via a messaging platform within the mobile app associated with the platform, for example. In particular embodiments, the content link may be provided in a manner requested by the user.

In an operation 308, the user may forward the content link to one or more recipients. For example, the user may copy the link (which may include taking a screenshot of the link if it is QR code displayed on the system 102) and include it in a text message or an email message to the one or more recipients. Additionally and/or alternatively, the user may copy the link and include it in a social media post. In some embodiments, multimedia system 102 may provide for the link to be sent to other users associated with the system (e.g., other subscribers to the proprietary streaming service platform) within the system. In such embodiments, a list of “friends” of the user may be developed and/or maintained by the system 102 based on user selection and past interaction and the user may select individual recipients from the list. Additionally and/or alternatively, in such embodiments, system 102 may provide user with a list of suggested recipients who may or may not be known to user (i.e., who may or may not be “friends” of the user within the system) based on interests of the suggested recipients known to the system and metadata associated with the content.

Although the operations of the example method shown in and described with reference to FIG. 3A are illustrated as occurring once each and in a particular order, it will be recognized that the operations may be performed in any suitable order and repeated as desired. Additionally, one or more operations may be performed in parallel. Furthermore, the operations illustrated in FIG. 3A may be combined or may include more or fewer details than described.

FIG. 3B is a flow diagram 320 of example operations performed by a content link sharing system, such as system 135 (FIG. 1) according to some embodiments of the disclosure. In certain embodiments, one or more of the operations illustrated in FIG. 3B may be performed by one or more of the elements illustrated in FIGS. 1-2, for example.

In an operation 322, a request for a content link is received from a user. In particular embodiments, the request is made while the user is viewing the content for which the content link is requested on the system 102 or on the user's mobile device 136 and may be made in the manner that any queries or requests may be made of the system, such as text, voice, or selection from a menu displayed on the user's mobile device or a display of the system.

In an operation 324, the content link is either generated, if the content is provided by a content server associated with the proprietary streaming platform on which the content is being viewed, or requested from a 3P streaming platform with which the content server from which the content is being streamed is provided (i.e., if system 102 does not have access to information about the content, including the identity thereof and/or metadata associated therewith). The content link may be in one of a variety of formats, including a URL, a QR code, or a token. The content link may include information about the user and may be in a format requested by the user. The content link may include an identity of the content, metadata associated with the content, and/or a thumbnail associated with the content. The content link may have a timestamp and may be set to expire after a predetermined amount of time.

In an operation 326, the content link is forwarded directly to one or more recipients identified by the user. In some embodiments, the recipients are other users associated with the system (e.g., other subscribers to the proprietary streaming service platform) and the link is sent within the system. As noted above, in such embodiments, a list of “friends” of the user may be developed and/or maintained by the system 102 based on user selection and past interaction and the user may select individual recipients from the list. Additionally and/or alternatively, in such embodiments, system 102 may provide user with a list of suggested recipients who may or may not be known to user (i.e., who may or may not be “friends” of the user within the system) based on interests of the suggested recipients known to the system and metadata associated with the content.

In operation 328, whether or not recipients click on the link is tracked for each recipient. For example, if the link is sent to a single recipient, a determination will be made whether the recipient clicks on the link before the link expires. If the link is sent to multiple recipients, a determination will be made which of the recipients, if any, click on the link. It will be recognized that additional information may be tracked, depending on the data available to system 102, such as how long after receiving the link the recipient clicked on it and/or whether the recipient saved the content to a favorites list, for example.

Although the operations of the example method shown in and described with reference to FIG. 3B are illustrated as occurring once each and in a particular order, it will be recognized that the operations may be performed in any suitable order and repeated as desired. Additionally, one or more operations may be performed in parallel. Furthermore, the operations illustrated in FIG. 3B may be combined or may include more or fewer details than described.

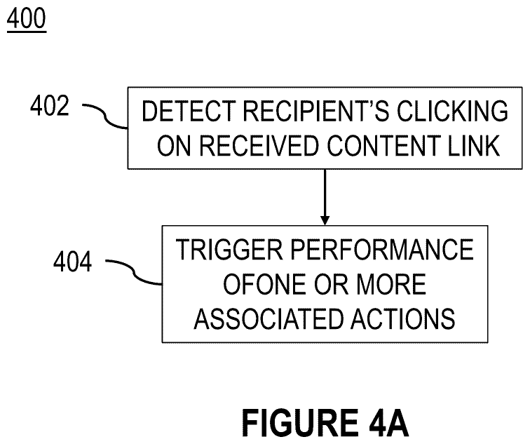

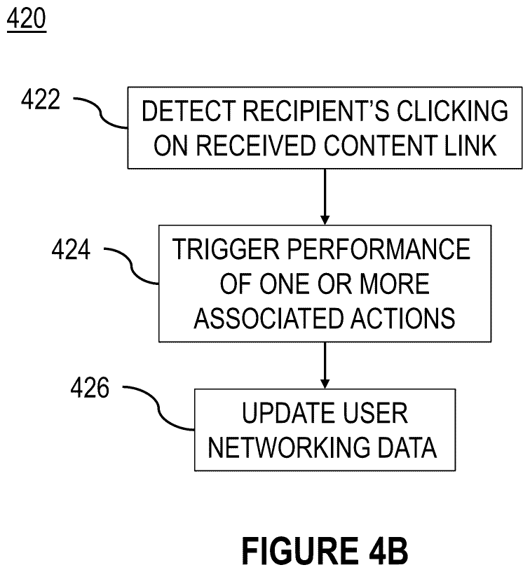

FIG. 4A is a flow diagram 400 of example operations performed by a content link sharing system, such as system 135 (FIG. 1) according to some embodiments of the disclosure. In certain embodiments, one or more of the operations illustrated in FIG. 4A may be performed by one or more of the elements illustrated in FIGS. 1-2, for example.

In an operation 402, clicking by a recipient on a content link generated as described above is detected.

In an operation 404, one or more actions are triggered, or initiated, in response to the recipient's clicking the content link. For example, clicking the link may immediately launch the associated content on the recipient's system or mobile device. Additionally and/or alternatively, clicking the link may result in the display of a thumbnail and a summary of the content along with a button for the recipient to click to launch presentation of the content. Moreover, clicking on the link may result in the content being added to the recipient's favorites list or to a “recommended” list, which list may be further ordered by an identity of the user who made the recommendations in the associated list (e.g., “Recommended by Bob S.,” “Recommended by Tiffany L.”) Still further, clicking the link may result in display of a menu from which the recipient may select one of the previous actions or another action, for example.

Although the operations of the example method shown in and described with reference to FIG. 4A are illustrated as occurring once each and in a particular order, it will be recognized that the operations may be performed in any suitable order and repeated as desired. Additionally, one or more operations may be performed in parallel. Furthermore, the operations illustrated in FIG. 4A may be combined or may include more or fewer details than described.

FIG. 4B is a flow diagram 420 of example operations performed by a content link sharing system, such as system 135 (FIG. 1) according to some embodiments of the disclosure. In certain embodiments, one or more of the operations illustrated in FIG. 4B may be performed by one or more of the elements illustrated in FIGS. 1-2, for example.

In an operation 422, clicking by a recipient on a content link generated as described above is detected.

In an operation 424, one or more actions are triggered, or initiated, in response to the recipient's clicking the content link. For example, clicking the link may immediately launch the associated content on the recipient's system or mobile device. Additionally and/or alternatively, clicking the link may result in the display of a thumbnail and a summary of the content along with a button for the recipient to click to launch presentation of the content. Moreover, clicking on the link may result in the content being added to the recipient's favorites list or to a “recommended” list, which list may be further ordered by an identity of the user who made the recommendations in the associated list (e.g., “Recommended by Bob S.,” “Recommended by Tiffany L.”) Still further, clicking the link may result in display of a menu from which the recipient may select one of the previous actions or another action, for example.

In an operation 426, the networking data of the user and/or the recipients may be updated for later use by the system 102. For example, the preferences of the user and/or recipients may be updated based on whether the recipients clicked on the received content link. Additionally and/or alternatively, the preferences of the user may be updated based on with whom the user shared the content link.

Although the operations of the example method shown in and described with reference to FIG. 4B are illustrated as occurring once each and in a particular order, it will be recognized that the operations may be performed in any suitable order and repeated as desired. Additionally, one or more operations may be performed in parallel. Furthermore, the operations illustrated in FIG. 4B may be combined or may include more or fewer details than described.

In alternative embodiments and/or enhancements to the above embodiments, content links may include links to items other than items of content that the user would like to share with one or more recipient(s). For example, a content link may comprise a link to the user's watch list (or favorites list) or a link to results of a particular search performed by the user.

It will be recognized that the content link may be a human readable link or may be a link that obscures the identity of the content. Additionally, launching of content that is the subject of a content link may require that the recipient have appropriate credentials (including in some cases a subscription) with the content server on which the content is stored.

### Example Computing Device

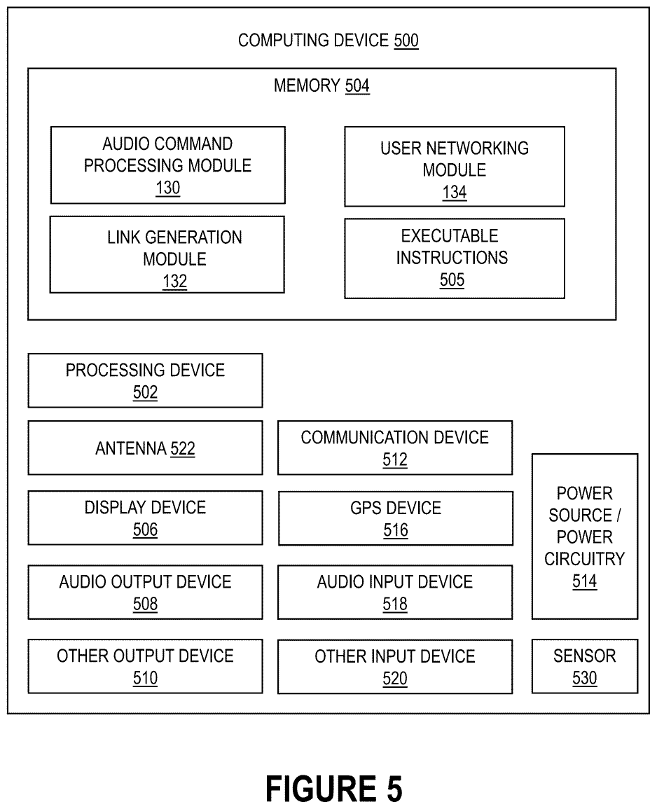

FIG. 5 is a block diagram of an example computing device 500, according to some embodiments of the disclosure. One or more computing devices 500 may be used to implement the functionalities described herein. A number of components are illustrated in the FIGURES as included in the computing device 500; however, it will be recognized that any one or more of these components may be omitted or duplicated, as suitable for the application. In some embodiments, some or all the components included in the computing device 500 may be attached to one or more motherboards. In some embodiments, some or all these components are fabricated onto a single system on a chip (SoC) die. Additionally, in various embodiments, the computing device 500 may not include one or more of the components illustrated in FIG. 5, and the computing device 500 may include interface circuitry for coupling to the one or more components. For example, the computing device 500 may not include a display device 506, and may include display device interface circuitry (e.g., a connector and driver circuitry) to which a display device 506 may be coupled. In another set of examples, the computing device 500 may not include an audio input device 518 or an audio output device 508 and may include audio input or output device interface circuitry (e.g., connectors and supporting circuitry) to which an audio input device 518 or audio output device 508 may be coupled.

The computing device 500 may include a processing device 502 (e.g., one or more processing devices, one or more of the same type of processing device, one or more of different types of processing device). The processing device 502 may include electronic circuitry that process electronic data from data storage elements (e.g., registers, memory, resistors, capacitors, quantum bit cells) to transform that electronic data into other electronic data that may be stored in registers and/or memory. Examples of processing device 502 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 500 may include a memory 504, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 504 includes one or more non-transitory computer-readable storage media. In some embodiments, memory 504 may include memory that shares a die with the processing device 502.

In some embodiments, memory 504 includes one or more non-transitory computer-readable media storing instructions executable to perform operations described herein and as shown in the FIGURES, such as FIGS. 3A, 3B, 4A and 4B.

Memory 504 may store instructions 505 that encode one or more exemplary parts. Exemplary parts that may be encoded as instructions and stored in memory 504 are depicted. Exemplary parts may include one or more components of system 135 of FIG. 1. The instructions stored in the one or more non-transitory computer-readable media may be executed by processing device 502.

In some embodiments, the computing device 500 may include a communication device 512 (e.g., one or more communication devices). For example, the communication device 512 may be configured for managing wired and/or wireless communications for the transfer of data to and from the computing device 500. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not. The communication device 512 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are referred to as WiMAX networks, an acronym that stands for worldwide interoperability for microwave access, which is a certification mark for products that pass conformity and interoperability tests for the IEEE 802.16 standards. The communication device 512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 512 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 512 may operate in accordance with other wireless protocols in other embodiments. The computing device 500 may include an antenna 522 to facilitate wireless communications and/or to receive other wireless communications (such as radio frequency transmissions). The computing device 500 may include receiver circuits and/or transmitter circuits. In some embodiments, the communication device 512 may manage wired communications, such as electrical, optical, or any other suitable communication protocols (e.g., the Ethernet). As noted above, the communication device 512 may include multiple communication chips. For instance, a first communication device 512 may be dedicated to shorter-range wireless communications such as Wi-Fi or Bluetooth, and a second communication device 512 may be dedicated to longer-range wireless communications such as global positioning system (GPS), EDGE, GPRS, CDMA, WiMAX, LTE, EV-DO, or others. In some embodiments, a first communication device 512 may be dedicated to wireless communications, and a second communication device 512 may be dedicated to wired communications.

The computing device 500 may include power source/power circuitry 514. The power source/power circuitry 514 may include one or more energy storage devices (e.g., batteries or capacitors) and/or circuitry for coupling components of the computing device 500 to an energy source separate from the computing device 500 (e.g., DC power, AC power, etc.).

The computing device 500 may include a display device 506 (or corresponding interface circuitry, as discussed above). The display device 506 may include any visual indicators, such as a heads-up display, a computer monitor, a projector, a touchscreen display, a liquid crystal display (LCD), a light-emitting diode display, or a flat panel display, for example.

The computing device 500 may include an audio output device 508 (or corresponding interface circuitry, as discussed above). The audio output device 508 may include any device that generates an audible indicator, such as speakers, headsets, or earbuds, for example.

The computing device 500 may include an audio input device 518 (or corresponding interface circuitry, as discussed above). The audio input device 518 may include any device that generates a signal representative of a sound, such as microphones, microphone arrays, or digital instruments (e.g., instruments having a musical instrument digital interface (MIDI) output).

The computing device 500 may include a GPS device 516 (or corresponding interface circuitry, as discussed above). The GPS device 516 may be in communication with a satellite-based system and may receive a location of the computing device 500, as known in the art.

The computing device 500 may include a sensor 530 (or one or more sensors). The computing device 500 may include corresponding interface circuitry, as discussed above). Sensor 530 may sense physical phenomenon and translate the physical phenomenon into electrical signals that can be processed by, e.g., processing device 502. Examples of sensor 530 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 500 may include another output device 510 (or corresponding interface circuitry, as discussed above). Examples of the other output device 510 may include an audio codec, a video codec, a printer, a wired or wireless transmitter for providing information to other devices, haptic output device, gas output device, vibrational output device, lighting output device, home automation controller, or an additional storage device.

The computing device 500 may include another input device 520 (or corresponding interface circuitry, as discussed above). Examples of the other input device 520 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 500 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 500 may be any other electronic device that processes data.

### Select Examples

Example 1 provides a computer-implemented method including receiving by a content link sharing system a request for a content link associated with content being viewed by a user; generating by the content link sharing system the requested content link; and providing by the content link sharing system the generated content link, in which the content link is configured to be copied by the user and shared with at least one recipient.

Example 2 provides the computer-implemented method of example 1, in which a format of the content link includes at least one of a quick response (QR) code, a uniform resource locator (URL), or a token.

Example 3 provides the computer-implemented method of example 2, in which the format is selected by the user prior to the generation of the content link.

Example 4 provides the computer-implemented method of any one of examples 1-3, in which the content being viewed by the user resides on a content server controlled by a third party streaming service.

Example 5 provides the computer-implemented method of example 4, in which the generating further includes requesting the content link from the third party streaming service.

Example 6 provides the computer-implemented method of any one of examples 1-5, further including detecting that the at least one recipient has clicked on the content link.

Example 7 provides the computer-implemented method of example 6, further including, subsequent to the detecting, triggering at least one action with respect to the content.

Example 8 provides the computer-implemented method of example 7, in which the at least one action includes at least one of launching presentation of the content on a device associated with the at least one recipient, adding the content to a watch list of the at least one recipient, and displaying at least one of a thumbnail and a summary of the content on the device associated with the at least one recipient.

Example 9 provides the computer-implemented method of any one of examples 6-8, further including, subsequent to the detecting, updating profile data of the user maintained by the content link sharing system.

Example 10 provides the computer-implemented method of any one of examples 1-9, in which the content link is human-readable.

Example 11 provides the computer-implemented method of any one of examples 1-10, in which the recipient is selected from a list of possible recipients provided by the content link sharing system.

Example 12 provides one or more non-transitory computer-readable media storing instructions that, when executed by one or more processors, cause the one or more processors to: receive a request for a content link associated with content being viewed by a user; generate the requested content link; share the content link to at least on recipient identified by the user; detect that the at least one recipient has clicked on the shared content link; and subsequent to the detecting, trigger at least one action with respect to the content.

Example 13 provides the one or more non-transitory computer-readable media of example 12, in which a format of the content link includes at least one of a quick response (QR) code, a uniform resource locator (URL), or a token.

Example 14 provides the one or more non-transitory computer-readable media of example 12 or 13, in which the content being viewed by the user resides on a content server controlled by a third party streaming service and in which the generating further includes requesting the content link from the third party streaming service.

Example 15 provides the one or more non-transitory computer-readable media of any one of examples 12-14, in which the at least one action includes at least one of launching presentation of the content on a device associated with the at least one recipient, adding the content to a watch list of the at least one recipient, and displaying at least one of a thumbnail and a summary of the content on the device associated with the at least one recipient.

Example 16 provides the one or more non-transitory computer-readable media of any one of examples 12-15, in which the instructions when executed by the one or more processors further cause the one or more processors to, subsequent to the detecting, update profile data of the user maintained by the content link sharing system.

Example 17 provides the one or more non-transitory computer-readable media of any one of examples 12-16, in which the instructions when executed by the one or more processors further cause the one or more processors to provide to the user a list of possible recipients.

Example 18 provides a system, including a media device; and a content link sharing system associated with the media device, the content link sharing system configured to: receive a request for a content link associated with content being viewed by a user using the media device; generate by the content link sharing system the requested content link; and provide by the content link sharing system the generated content link, in which the content link is configured to be copied by the user and shared with at least one recipient.

Example 19 provides the system of example 18, in which a format of the content link includes at least one of a quick response (QR) code, a uniform resource locator (URL), or a token.

Example 20 provides the system of example 18 or 19, in which the media device is associated with a first streaming service provider and the content being viewed by the user resides on a content server controlled by a second streaming service provider and in which the generating further includes requesting the content link from the second streaming service provider.

### Variations and Other Notes

Although the operations of the example methods shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure considering the above detailed description.

For purposes of explanation, specific numbers, materials, and configurations are set forth to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. These operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” refer to being within +/−20% of a target value as described herein or as known in the art. Similarly, terms indicating orientation of various elements, e.g., “coplanar,” “perpendicular,” “orthogonal,” “parallel,” or any other angle between the elements, refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description and the accompanying drawings.

1. A computer-implemented method comprising:
receiving by a content link sharing system a request from a user for a content link associated with multimedia content, wherein the request is received while the user is viewing the multimedia content via a streaming device;
generating by the content link sharing system the requested content link, wherein a format of the requested content link is selected by the user; and
providing by the content link sharing system the generated content link, wherein the content link is configured to be copied by the user and pasted into an electronic message to at least one recipient.

2. The computer-implemented method of claim 1, wherein the format of the content link comprises at least one of a quick response (QR) code, a uniform resource locator (URL), or a token.

3. (canceled)

4. The computer-implemented method of claim 1, wherein the multimedia content being viewed by the user resides on a multimedia content server controlled by a third party streaming service.

5. The computer-implemented method of claim 4, wherein the generating further comprises requesting the content link from the third party streaming service.

6. The computer-implemented method of claim 1, further comprising detecting that the at least one recipient has clicked on the content link.

7. The computer-implemented method of claim 6, further comprising, subsequent to the detecting, triggering at least one action in connection with the multimedia content.

8. The computer-implemented method of claim 7, wherein the at least one action comprises at least one of launching presentation of the multimedia content on a streaming device associated with the at least one recipient, adding the multimedia content to a watch list of the at least one recipient, and displaying at least one of a thumbnail image and a summary of the multimedia content on the device associated with the at least one recipient.

9. The computer-implemented method of claim 6, further comprising, subsequent to the detecting, updating profile data of the user maintained by the content link sharing system.

10. The computer-implemented method of claim 1, wherein the content link is human-readable.

11. The computer-implemented method of claim 1, wherein the recipient is selected from a list of possible recipients provided by the content link sharing system.

12. One or more non-transitory computer-readable media storing instructions that, when executed by one or more processors, cause the one or more processors to:
receive a request for a content link associated with multimedia content being viewed by a user via a multimedia streaming device, wherein the request is received while the user is viewing the multimedia content;
generate the requested content link, wherein a format in which the content link is generated is selected by the user and wherein the content link is configured to be copied by the user and pasted into an electronic message to be shared with at least one recipient;
detect that the at least one recipient has clicked on the shared content link; and
subsequent to the detecting, trigger at least one action with respect to the content.

13. The one or more non-transitory computer-readable media of claim 12, wherein the format of the content link comprises at least one of a quick response (QR) code, a uniform resource locator (URL), or a token.

14. The one or more non-transitory computer-readable media of claim 12, wherein the multimedia content being viewed by the user resides on a multimedia content server controlled by a third party streaming service and wherein the generating further comprises requesting the content link from the third party streaming service.

15. The one or more non-transitory computer-readable media of claim 12, wherein the at least one action comprises at least one of launching presentation of the multimedia content on a multimedia streaming device associated with the at least one recipient, adding the content to a watch list of the at least one recipient, and displaying at least one of a thumbnail and a summary of the content on the device associated with the at least one recipient.

16. The one or more non-transitory computer-readable media of claim 12, wherein the instructions when executed by the one or more processors further cause the one or more processors to, subsequent to the detecting, update profile data of the user maintained by a content link sharing system.

17. The one or more non-transitory computer-readable media of claim 12, wherein the instructions when executed by the one or more processors further cause the one or more processors to provide to the user a list of possible recipients.

18. A system, comprising:
a multimedia streaming device; and
a content link sharing system associated with the multimedia streaming device, the content link sharing system comprising a processor and a memory for storing instructions executable by the processor, the content link sharing system configured to:
receive a request from a user for a content link associated with multimedia content, wherein the request is received while the user is viewing the multimedia content via a streaming device;
generate by the content link sharing system the requested content link, wherein a format of the requested content link is selected by the user; and
provide by the content link sharing system the generated content link, wherein the content link is configured to be copied by the user and pasted into an electronic message sent to at least one recipient.

19. The system of claim 18, wherein the format of the content link comprises at least one of a quick response (QR) code, a uniform resource locator (URL), or a token.

20. The system of claim 18, wherein the multimedia streaming device is associated with a first streaming service provider and the multimedia content being viewed by the user resides on a multimedia content server controlled by a second streaming service provider and wherein the generating further comprises requesting the content link from the second streaming service provider.
